(19) United States
(12) Patent Application Publication
(10) Pub. No.: US 2007/0196700 A1
(43) Pub. Date: Aug. 23, 2007

(54) Method of supplying fuel to fuel cells

(75) Inventors: Charn-Ying Chen, Taoyuan City (TW); Chun-Lung Chang, Hu-ko (TW); Chi-Yuan Chang, Taichung City (TW); Yun Bor Lin, Taoyuan (TW)

Correspondence Address: BRUCE H. TROXELL, SUITE 1404, 5205 LEESBURG PIKE, FALLS CHURCH, VA, 22041, US

(73) Assignee: Institute OF NUCLEAR ENERGY RESEARCH ATOMIC ENERGY COUNCIL, EXECUTIVE YUAN

(21) Appl. No.: 11/488,738

(22) Filed: Jul. 19, 2006

(30) Foreign Application Priority Data
Feb. 23, 2006 (TW) 095106024

(51) Int. Cl. H01M 8/04

(52) U.S. Cl. 429/13; 429/22; 429/23

(57) ABSTRACT

The present invention relates a method of supplying fuel to a fuel cell, which comprises steps of: feeding a specific amount of a fuel into a fuel cell; obtaining a second characteristic value at a specific time point; detecting and measuring a character of the fuel cell at a time interval before the specific time point for obtaining a second characteristic value; comparing the second characteristic value to the first characteristic value for enabling the fuel to be fed into the fuel cell while the second characteristic value is smaller that the first characteristic value. By the aforesaid method, the supplying of fuel to the fuel cell can be effectively controlled for optimizing the performance of the fuel cell without the use of fuel sensor required thereby and thus reducing the cost and complexity of manufacturing the fuel cell system.

### FIELD OF THE INVENTION

The present invention is related to a method of supplying fuel, and, more specifically, to a method of supplying fuel to fuel cells, wherein, during the reaction of the fuel cells, the operating characteristics of the fuel cells, such as potential, current or power, are monitored and measured, whereby the fuel supply are controlled for maintaining performance without any installation of fuel concentration sensors in the fuel cells' operating system.

### BACKGROUND OF THE INVENTION

Fuel cell is a kind of power generating device that transforms from chemical energy to electrical energy through electrochemical reaction. With a continuous feeding of the fuel, the fuel cell can react to generate power of electricity persistently. Since the production of the fuel cell is water, it will not contaminate the environment. With the merits of lower pollution and higher efficiency, the development and improvement of the fuel cells are now becoming the main stream in the power generation field.

Among the fuel cells, a direct methanol fuel cell or so called DMFC is a promising candidate for portable applications in recently years. The difference between DMFC and other power generating devices, such as PEMFC, is that the DMFC takes methanol as fuel in substitution for hydrogen. Because of utilizing liquid methanol as fuel for reaction, the DMFC eliminates the on board H₂ storage problem so that the risk of explosion in the use of fuel cells is avoided, which substantially enhances the convenience and safety of fuel cells and makes DMFC more adaptable to portable electronic appliances such as Laptop, PDA, GPS and etc, in the future.

During the electrochemical reaction occurred in the fuel cell, the fuel concentration is a vital parameter affecting the performance of the liquid feed fuel cell system. However, DMFC suffers from a problem that is well known to those skilled in the art: methanol cross-over from anode to cathode through the membrane of electrolyte, which causes significant loss in efficiency. It is important to regulate the supplying of fuel appropriately to keep methanol concentration in a predetermined range whereby DMFCs system can operate optimally. For example, a fuel sensor, such as methanol concentration sensor disclosed in the prior art, is utilized to detect the concentration of methanol so as to provide information for controlling system to judge a suitable timing to supply methanol. Although the foregoing method is capable of controlling the concentration of the fuel, it still has the drawbacks of increasing the complexity and cost of the fuel cells system. And a lot of experimental effort like calibration is necessary through the use of concentration sensor.

In order to reduce the cost and complexity caused by the additional concentration sensor in the prior arts, a couple of sensorless control for DMFCs approaches have been disclosed to decrease the cost and complexity of the fuel cells system and improve the stability of fuel cell operation by monitoring one or more of the fuel cells' operating characteristics. For instance, in U.S. Pat. No. 6,589,679, a change of methanol concentration is introduced by periodically reducing or interrupting the amount of methanol supplied to fuel cell and the rate of the potential drop can be used; or the potential difference between the inlet and outlet of the methanol flow can be used; or the load is periodically disconnected from the fuel cell and the open-circuit potential can be used to adjust the methanol concentration. Moreover, a prior art, disclosed in U.S. Pat. No. 6,824,899, provides a method to optimize the concentration of methanol by detecting the short circuit current. However, since periodically short circuit to detect the current is necessary, it is easily to damage the fuel cells itself so as to affect the stability of the fuel cells system. Meanwhile, in U.S. Pat. No. 6,698,278, the way to control the concentration of methanol is to calculate methanol concentration in the fuel stream based on the measurement of the temperature of the fuel stream entering the fuel cell stack, the fuel cell stack operating temperature, and the load current. However, the foregoing disclosing methods are based on the predetermined calibration of the fuel cells system and on empirical models. The monitoring and control of the methanol concentration are loose due to the complexity of fuel cells operation and MEA degradation.

According to the drawbacks of the prior arts described above, it deserves to provide a method for supplying fuel to fuel cells to solve the problem of the prior arts.

### SUMMARY OF THE INVENTION

A primary object of the present invention is to provide a method of supplying fuel to fuel cells, wherein operating characteristics of the fuel cell, such as potential, electric current or power, during reaction are measured so that numerical calculation and correlation can be processed to determine the appropriate timing for fuel supplying so as to achieve the object of optimizing the output of the fuel cells.

A further object of the present invention is to provide a method of supplying fuel to fuel cells, wherein operating characteristics of the fuel cells during reaction are measured and correlated to control the fuel supplying without any setting of methanol concentration sensor so as to achieve the object of low cost, accurate and precise control.

For achieving the objects described above, the present invention provides a method of supplying fuel to fuel cells, comprising steps of: feeding a specific amount of a fuel into a fuel cell; obtaining a first characteristic value of the fuel cell within a monitoring time period; obtaining a second characteristic value of the fuel cell while the monitoring time period is over; and comparing the second characteristic value to the first characteristic value and enabling the fuel to be fed into the fuel cell while the second characteristic value is smaller than the first characteristic value.

More preferably, the first characteristic value is a value selected from the group consisting of a minimum voltage value, a minimum current value, and a minimum power value, each of which is measured over the monitoring time period. Besides, the first characteristic value may also be a value selected from the group consisting of a moving average value of measured characteristic of the fuel cell over the monitoring time period and a root mean square value of measured characteristic of the fuel cell over the monitoring time period.

More preferably, the monitoring time period is a duration that a specific power is generated to sustain a specific load through the specific amount of fuel, wherein the specific power is a maximum power in a polarization curve generated from the fuel cell to the load during the reaction of the specific amount of the fuel or is a smaller value prior to the maximum power in a polarization curve generated from the fuel cell.

More preferably, the method further comprises the steps of: if the second characteristic value is larger than the first characteristic value then obtaining a third characteristic value in a time point after the monitoring time period; obtaining a fourth characteristic value of the fuel cell before the time point; and comparing the third characteristic value to the fourth value, if the third characteristic value is smaller than the fourth characteristic value then feeding the fuel into the fuel cell. The fourth characteristic value may be a value selected from the group consisting of a moving average value of measured characteristic values of the fuel cell over a time interval before the time point or a root mean square value of measured characteristic values of the fuel cell over a time interval before the time point.

More preferable, the fuel is substantially a hydrogen-rich liquid fuel.

For achieving the objects described above, the present invention further provides a method of supplying fuel to a fuel cell, comprising steps of: (a) feeding a specific amount of a fuel into a fuel cell; (b) obtaining a first characteristic value of the fuel cell within a monitoring time period; (c)obtaining a second characteristic value of the fuel cell while the monitoring time period is over; (d) repeating the step (a) while the second characteristic value is smaller than the first characteristic value; (e) obtaining a third characteristic value in a time point after the monitoring time period; (f) obtaining a fourth characteristic value of the fuel cell before the time point; and (g) repeating the step (a) while the third characteristic value is smaller than the fourth characteristic value.

More preferably, the method further comprises the step of repeating the step (e) while the third characteristic value is larger than the fourth characteristic value.

### BRIEF DESCRIPTION OF THE DRAWINGS

The drawings, incorporated into and form a part of the disclosure, illustrate the embodiments and method related to this invention and will assist in explaining the detail of the invention.

FIG. 1 is a flow chart illustrating the preferred embodiment according to the present invention.

FIG. 2 is a flow chart illustrating another preferred embodiment according to the present invention.

FIG. 3 is a schematic illustration of polarization curve during the reaction of the fuel cell after receiving a specific amount of fuel.

FIG. 4 is a schematic illustration depicting the relationship of voltage and time of the fuel cell during reaction.

FIG. 5A is a schematic illustration of the fuel cell connecting to a load.

FIG. 5B is a schematic illustration depicting the way sensing the electric current of the load.

FIG. 6 is a schematic illustration of the way for data acquiring in the present invention.

### DESCRIPTION OF THE PREFERRED EMBODIMENT

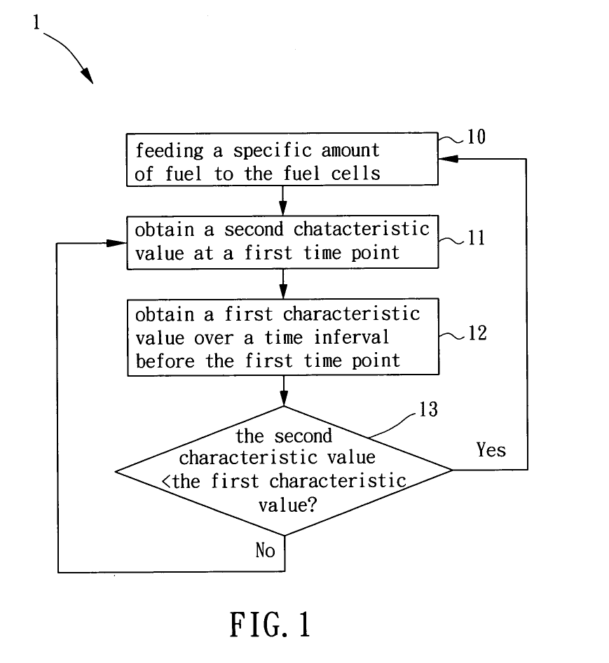

Please refer to FIG. 1 which is a flow chart illustrating the preferred embodiment according to the present invention. The method is described in the following. Firstly, as illustrated in step 10, a specific amount of a fuel is fed into a fuel cell. Then, as illustrated in step 11, a second characteristic value is obtained at a time point that locates at the last of a monitor time interval wherein the characteristic value can be a value like potential, current, or power output of the fuel cell. Next, following step 12, measuring characters of the fuel cell over the monitoring time interval before the second characteristic value for obtaining a first characteristic value. The character refers to an operating characteristic of the fuel cell, such as potential, current, or power output, for example. Finally, as shown in step 13, the first characteristic value is compared to the second characteristic value for enabling the fuel to be fed into the fuel cell while the second characteristic value is smaller than the first characteristic value. The first characteristic value may be a minimum voltage value, a minimum current value, or a minimum power value of the measured character over the time interval. In addition, the first characteristic value may also be a moving average value of the measured characters of the fuel cell over the time interval or a root mean square value of the measured characters of the fuel cell over the monitoring time interval.

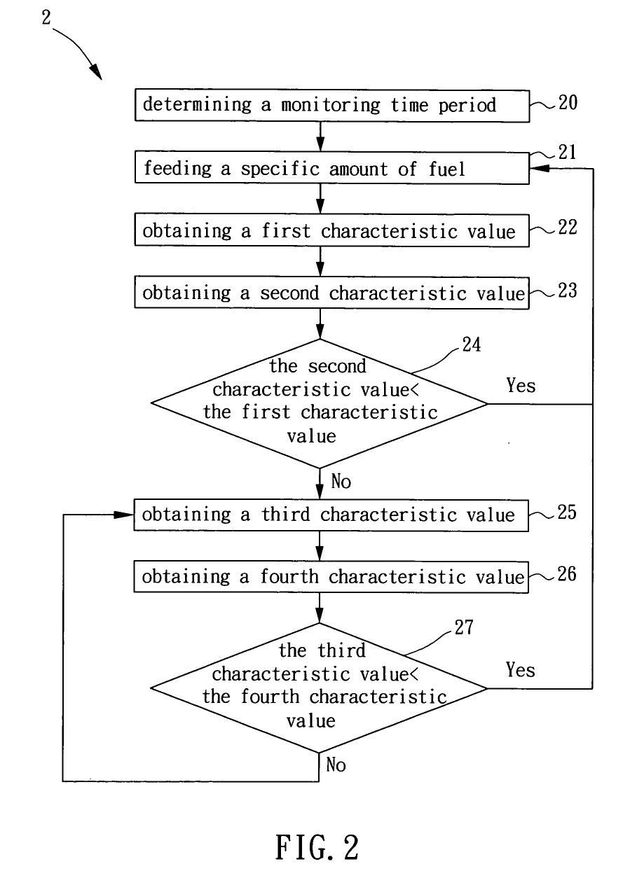

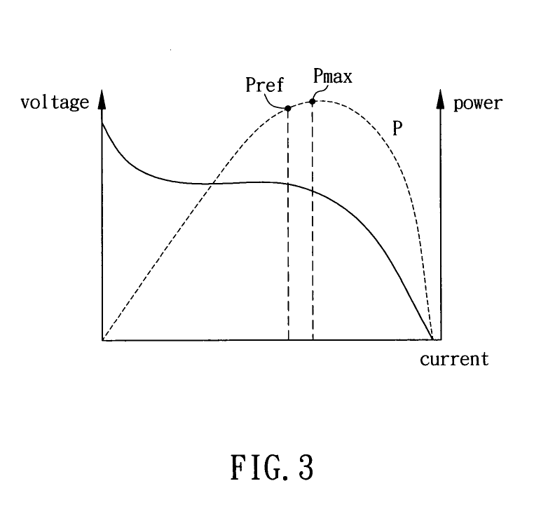

Please refer to FIG. 2 which is a flow chart illustrating another preferred embodiment according to the present invention. The method of supplying fuel for a fuel cell is started at step 20 to determine a monitoring time period. Please refer to FIG. 3, which is a schematic illustration of polarization curve during the reaction of the fuel cell after receiving a specific amount of fuel and which is taken to be an illustration explaining the way to determine the monitoring time period. The polarization curve depicts the relationship between voltage and current density when the fuel cell is connected to a load and fed a specific amount of fuel; meanwhile a power curve corresponding to the polarization curve is also illustrated in the FIG. 3. The power curve has a maximum power Pₘₐₓ. Therefore, the monitoring time period can be determined to be a duration that the fuel cell can output the maximum power Pₘₐₓ during the reaction within the injection of specific amount of fuel. In addition, in order to avoid overload, it is selected a power value P_{ref}, smaller than Pₘₐₓ shown in FIG. 3, to be a suggested value for deciding the length of the monitoring time period as well. In another words, the monitoring time period can be determined to be a time period that the fuel cell can output power P_{ref} during the reaction within the injection of specific amount of fuel. Of course, the value of power value, either Pₘₐₓ or P_{ref}, is dependent on the load required; hence, the determination of Pₘₐₓ or P_{ref} disclosed in this embodiment should not be a limitation of the present invention.

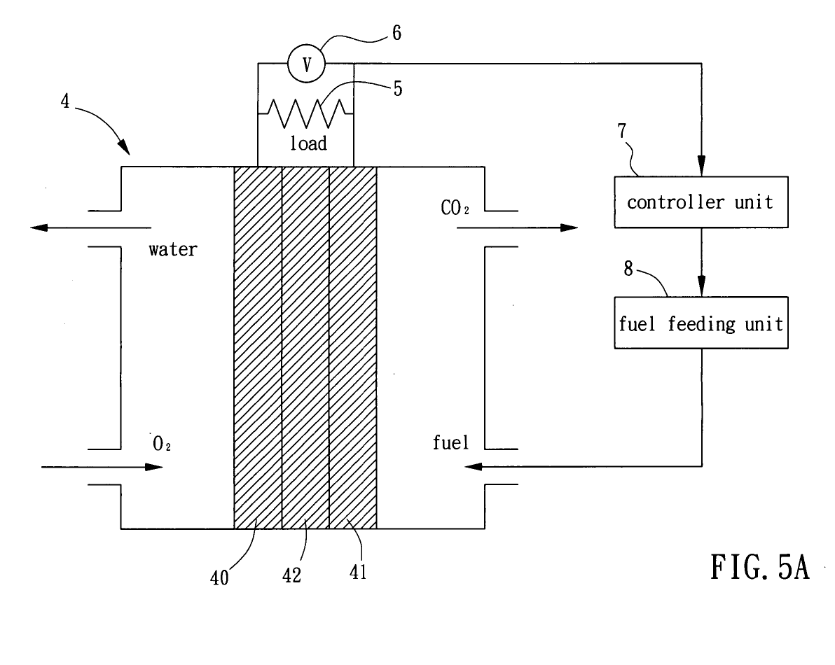

After the determination of the monitoring time period in step 20, the step 21 is processed to feed a specific amount of fuel in the fuel cell so that the fuel cell starts to generate power through the electrochemical reaction. The fuel according the present invention is substantially a hydrogen-rich liquid fuel such as methanol, ethanol and etc. Please refer to FIG. 5A, which is a schematic illustration of the fuel cell connecting to a load. The fuel cell 4, basically, comprise inlets for transporting methanol into anode 41 and transporting oxygen into cathode 40 of the fuel cell, while the fuel cell also comprises outlets for product water from cathode 40 and carbon dioxide from anode 41. The anode 41 and cathode 40 are disposed inside the middle location of the fuel cell 4, while a membrane of electrolyte 42 is disposed between the anode 41 and cathode 40. A load 5 is connected to the anode 41 and cathode 40 to form an electric circuit. A measuring device 6 is connected to the load 5 so as to measure a characteristic value, such as voltage or current, of the load. In this embodiment, the measuring device 6 is a potential measuring device that is electrically connected in parallel with the load 5. Alternatively, as shown in FIG. 5B, the measuring device 6 is capable of being a current measuring device that is connected in series with the load 5.

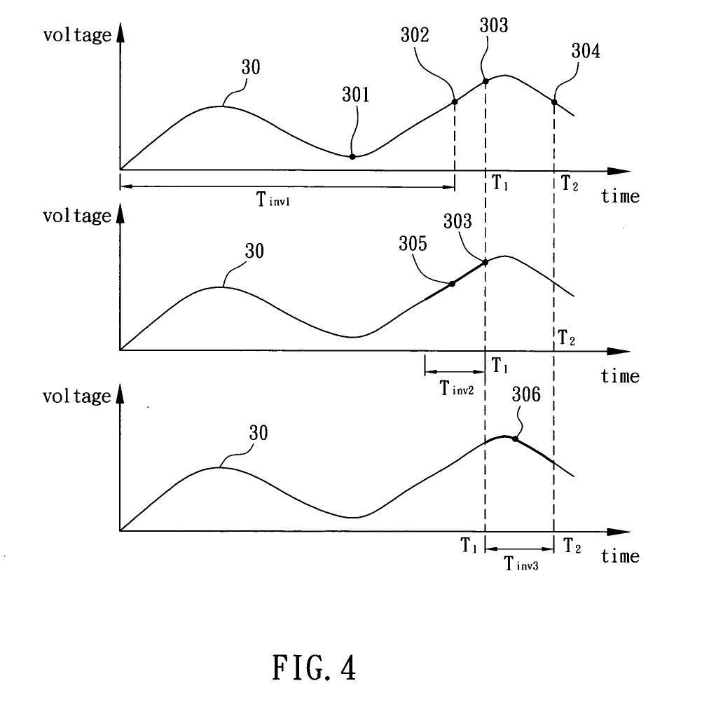

Step 22 is proceeded after step 21, wherein the potential measuring device 6, shown in FIG. 5A, measures the characteristic values of the load 5 over the monitoring time period and then sends those data to a controller unit 7. Please refer to FIG. 4, wherein a curve 30 represents the relationship of characteristic value over time of the fuel cell during reaction while the fuel cell receives the specific amount of fuel. The controller unit 7 will determine a first characteristic value 301, which is a minimum value among those measured characteristic values measured by the measuring device 6 over the monitoring time period Tᵢₙᵥ₁. Alternatively, the first characteristic value 301 may be replaced by a moving average value of the measured characteristic values of the fuel cell over the monitoring time period Tᵢₙᵥ₁, or a root mean square value of the measured characteristic values of voltage of the fuel cells over the monitoring time period Tᵢₙᵥ₁. In addition, the first characteristic value 301 may also be a minimum current value or a minimum power value, which depends on the type and configuration of system device. Next, in the step 23, the measuring device 6 measures a second characteristic value 302 at a point of time when the monitoring time period Tᵢₙᵥ₁, is just over. After that, in step 24, the controller unit 7 compares the first characteristic value 301 to the second characteristic value 302, and if the second characteristic value 302 is smaller than the first characteristic value then back to step 21 so that the controller unit 7 will signal the fuel feeding unit 8 to inject fuel in the fuel cell 4 and then repeat to keep monitoring.

If the second characteristic value of voltage 302 is larger than the first characteristic value 301, then the flow is processed to step 25 which is a step for obtaining a third characteristic value of voltage 303 at a time point T1. Then, as shown in step 26, a time interval Tᵢₙᵥ₂ before the time point T1 is decided so as to calculate a fourth characteristic value 305 which is a moving average value of the measured characteristics among the time interval Tᵢₙᵥ₂. In addition to the moving average value, the fourth characteristic value 305 can be a root mean square value, or the minimum voltage value over the time interval Tᵢₙᵥ₂.

After step 26, a step 27 is processed to determine whether controller unit 7 should feed fuel to the fuel cell 4 or not. If the third characteristic value 303 is smaller than the fourth characteristic value 305, it goes back to step 21, and the controller unit 7 signals the fuel feeding unit 8 to inject fuel to the fuel cell 4. If the third characteristic value of voltage 303 is larger than the fourth characteristic value 305, which is just the case shown in FIG. 4, then it goes back to step 25 to find another time point T2, shown in FIG. 4, to obtain another third characteristic value 304. Then repeat step 26 to determine another time interval Tᵢₙᵥ₃ for determining another fourth characteristic value 306, which is a moving average value of measured characteristic value over the time interval Tᵢₙᵥ₃. Then the third characteristic value 304 is compared to the fourth characteristic value 306; in this case, the third characteristic value 304 is smaller than the fourth characteristic value 306 so that the step of flow will return to step 21 to feed fuel to the fuel cells 4 and continue to process the whole flow repeatedly to monitor the operating status of the fuel cells 4.

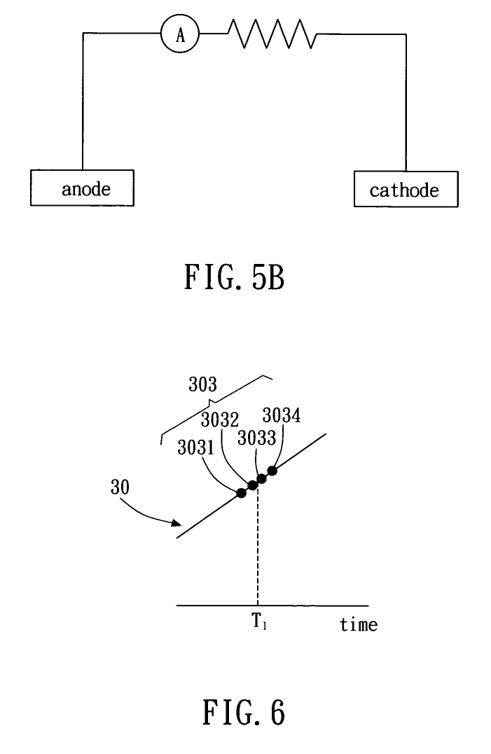

Please refer to FIG. 6, which is a schematic illustration of the way for data acquisition in the present invention. Besides single measurement to obtain the characteristic value, such as voltage, current and so on, it may also measure a plurality data to form a characteristic value through averaging so as to increase accuracy. Taking the second characteristic value 303 as an example, as shown in FIG. 6, it is possible to grab four data 3031, 3032, 3033, and 3034 around the time point T1 so that the controller unit 7 can calculate average of those four data 3031, 3032, 3033, and 3034 to form the second characteristic value 303. Of course the characteristic value 301˜306 shown in FIG. 4 can be calculated in such a way.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A method of supplying fuel to a fuel cells, comprising steps of:
feeding a specific amount of fuel into a fuel cell;
obtaining a first characteristic value of the fuel cell within a monitoring time period;
obtaining a second characteristic value of the fuel cell at the end of the monitoring time period; and
comparing the second characteristic value to the first characteristic value for enabling fuel to be fed into the fuel cell while the second characteristic value is smaller than the first characteristic value.

2. The method according to claim 1, wherein the first characteristic value is a value selected from the group consisting of a minimum voltage value, a minimum current value, and a minimum power value, each of which is measured over the monitoring time period.

3. The method according to claim 1, wherein the first characteristic value is a value selected from the group consisting of a moving average value of measured characteristic values of the fuel cell over the monitoring time period and a root mean square value of measured characteristic values of the fuel cell over the monitoring time period.

4. The method according to claim 1, wherein the monitoring time period is a duration that a specific power is generated to sustain a specific load through the specific amount of fuel.

5. The method according to claim 4, wherein the specific power is a maximum power in a polarization curve generated from the fuel cell to the load during the specific amount of the fuel is reacted.

6. The method according to claim 4, wherein the specific power is smaller than a maximum power in a polarization curve generated from the fuel cell to the load during the specific amount of the fuel is reacted.

7. The method according to claim 1, further comprising the steps of:
if the second characteristic value is larger than the first characteristic value then obtaining a third characteristic value in a time point after the monitoring time period;
obtaining a fourth characteristic value of the fuel cells before the time point; and
comparing the third characteristic value to the fourth value, if the third characteristic value is smaller than the fourth characteristic value then feed the fuel into the fuel cell.

8. The method according to claim 7, wherein the fourth characteristic value is a value selected from the group consisting of a moving average value of measured characteristic values of the fuel cell over a time interval before the time point and a root mean square value of measured characteristic values of the fuel cell over a time interval before the time point.

9. The method according to claim 1, wherein the fuel is substantially a hydrogen-rich liquid fuel.

10. A method of supplying fuel to a fuel cell, comprising steps of:
(a) feeding a specific amount of a fuel into a fuel cell;
(b) obtaining a first characteristic value of the fuel cell within a monitoring time period;
(c) obtaining a second characteristic value of the fuel cell while the monitoring time period is over;
(d) repeating the step (a) while the second characteristic value is smaller than the first characteristic value;
(e) obtaining a third characteristic value at a time point after the monitoring time period;
(f) obtaining a fourth characteristic value of the fuel cell before the time point; and
(g) repeating the step (a) while the third characteristic value is smaller than the fourth characteristic value.

11. The method according to claim 10 further comprising a step of repeating the step (e) while the third characteristic value is larger than the fourth characteristic value.

12. The method according to claim 10, wherein the first characteristic value is a value selected from the group consisting of a minimum voltage value, a minimum current value or a minimum power value of the fuel cell, each of which is measured from the fuel cell within the monitoring time period.

13. The method according to claim 10, wherein the monitoring time period is a duration that a specific power is generated to sustain a specific load through the specific amount of fuel.

14. The method according to claim 13, wherein the specific power is a maximum power in a polarization curve generated from the fuel cell to the load during the specific amount of the fuel is reacted.

15. The method according to claim 13, wherein the specific power is smaller than a maximum power in a polarization curve generated from the fuel cell to the load during the specific amount of the fuel is reacted.

16. The method according to claim 10, wherein the fourth characteristic value is a value selected from the group consisting of a moving average value of measured characteristic values of the fuel cell over a time interval before the time point and a root mean square value of measured characteristic values of the fuel cell over a time interval before the time point.

17. The method according to claim 10, wherein the fuel is substantially a hydrogen-rich liquid fuel.
